(19) United States
(12) Patent Application Publication
(10) Pub. No.: US 2007/0128577 A1
(43) Pub. Date: Jun. 7, 2007

(54) Dental curing lights including a capacitor power source

(75) Inventors: Robert R. Scott, Riverton, UT (US); Dee Jessop, West Jordan, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Ultradent Products, Inc., South Jordan, UT (US)

(21) Appl. No.: 11/294,159

(22) Filed: Dec. 5, 2005

(51) Int. Cl. A61C 3/00

(52) U.S. Cl. 433/29

(57) ABSTRACT

A dental curing light including a body defining a housing, at least one light generating device disposed on or within the housing, and a power source comprising at least one capacitor disposed within the housing for providing power to the at least one light generating device. The power source may comprise a plurality of capacitors that may be wired in parallel, series, or various combinations thereof.

### BACKGROUND OF THE INVENTION

1. The Field of the Invention

The present invention generally relates to the field of light curing devices. More particularly, the invention relates to dental curing light devices and related systems.

2. The Relevant Technology

In the field of dentistry, dental cavities are often filled and/or sealed with photosensitive dental compositions that are cured by exposure to radiant energy, such as visible light. These compositions, commonly referred to as light-curable compositions, are placed within dental cavity preparations or onto dental surfaces where they are subsequently irradiated by light. The radiated light causes photosensitive components within the compositions to initiate polymerization of polymerizable components, thereby hardening the light-curable composition within the dental cavity preparation or other dental surface.

Existing light-curing devices are typically configured with a light source, such as a quartz-tungsten-halogen (QTH) bulb or an LED light source. QTH bulbs are particularly useful because they are configured to generate a broad spectrum of light that can be used to cure a broad range of products. In particular, a QTH bulb is typically configured to emit a continuous spectrum of light in a preferred range of about 350 nm to about 500 nm. Some QTH bulbs may even emit a broader spectrum of light, although filters are typically used to limit the range of emitted light to the preferred range mentioned above.

More recently, some dental curing lights have been manufactured using alternative light generating sources, such as light-emitting diodes (LEDs) which are generally configured to only radiate light at a specific narrow range of wavelengths. LEDs are particularly suitable light sources because they generate much less heat than QTH bulbs, thereby enabling the LEDs to be placed at or nearer the tip of the curing lights and to be inserted directly within the patient's mouth. This is particularly useful for reducing or eliminating the need for light guides such as optical fiber wands that are typically used with QTH bulbs.

With either type of dental curing light, power is provided to the light source (e.g., the QTH bulb or one or more LEDs) and other components either by a power cord which can be connected to a power outlet or by an on-board battery pack integrated into the dental curing light. Dental curing lights with power cords have limited mobility, while battery packs are generally bulky and/or heavy, often comprising a substantial portion of the total weight of the device. Even for more lightweight and less bulky battery powered devices, the rechargeable battery packs can take as long as several hours to properly recharge, which can be a serious disadvantage if the battery is depleted during or between procedures or patients. Newly developed fast charging battery packs are claimed by some manufacturers to charge in as little as thirty minutes, but can become very hot during the recharge process as the charging chemical reaction can produce a significant amount of heat. Rechargeable battery packs also have a limited lifespan, with problems of “memory” or overcharging that can greatly reduce charging capacity over time.

In view of the foregoing, it would be an advantage to provide a dental curing light including an alternative power source that would allow the dental curing light to have increased mobility as compared to a corded dental curing light, while also being relatively light weight, compact, and quickly rechargeable without generating a significant amount of heat.

### SUMMARY OF THE INVENTION

The present invention is directed to a dental curing light including a body defining a housing, at least one light generating device disposed on or within the housing, and a power source disposed within the housing for providing power to the at least one light generating device. The power source advantageously comprises at least one capacitor.

The use of a capacitor power source provides distinct advantages to the dental curing light, as capacitors are generally lightweight and compact so as to provide a sufficient amount of power storage in a small volume and with far less weight compared to conventional rechargeable battery packs. This allows the body of the dental curing light to be relatively compact, which is advantageous when working within the oral cavity of a patient. In addition, capacitors can be quickly recharged, in significantly less time than batteries. Also, because capacitors do not store their charge chemically (as batteries do), there is little heat generation associated with charging the capacitor power source. Furthermore, capacitors can be recharged repeatedly (e.g., 10,000 times or more) without being damaged or losing capacity as batteries that suffer from a “memory” effect do. Also advantageously, a capacitor can discharge very quickly so as to provide a very high current if needed (e.g., during start up) while it is very difficult or impossible to discharge a small battery so as to provide a very high current in a controlled manner (i.e., without short circuiting the battery).

In one example, the power source may comprise a plurality of capacitors, which may be wired together in any desired configuration. For example, at least one of the capacitors may be wired in series with respect to another capacitor. In another example at least one of the capacitors may be wired in parallel with respect to another capacitor. In yet another example, the power source may include a plurality of capacitors including one or more capacitors wired in series and one or more capacitors wired in parallel. For example, the power source may include four capacitors where each capacitor is connected to one other capacitor in parallel such that the four capacitors are wired as two parallel pairs. One of the parallel pairs of capacitors may be wired to the other parallel pair in a series configuration.

The body of the dental curing light may be configured as an elongate wand housing. In one such example the at least one light generating device comprises at least one LED or LED array. The use of at least one LED or LED array light source may be particularly advantageous with use of a capacitor power source. LEDs emit light in a relatively narrow spectrum centered around the rated wavelength of the LED. This is in contrast to a bulb light source, which emits a wide spectrum of wavelengths, in addition to a significant amount of heat (so much so that bulb light sources are not placed near the distal light emitting end of the curing light as the excess heat can burn a patient).

Because of their efficiency, LEDs only require a relatively small amount of power, which is particularly well suited for use with a capacitor power supply. This is because although capacitors may be less preferred power supplies in many applications because they may not hold as much power as a similar sized battery, an LED only requires a small amount of power, and the capacitor can be quickly recharged. Thus, the combination of a capacitor power source and an LED light source is particularly advantageous as sufficient power is provided by the capacitor to drive the LED (which is typically driven for short time periods), and the capacitor can be recharged very quickly for reuse.

A related dental curing light system includes a dental curing light as described above and a charging base station configured to receive and recharge the capacitor power source of the dental curing light. The charging base station may be configured to at least partially receive the dental curing light and to charge the one or more capacitors of the dental curing light when the curing light is received within the charging base station. The charging base station may include an electrical power cord configured for connection to a power outlet, or the charging base station may include an alternative power source for charging the capacitor of the dental curing light. For example, a fuel cell, an air-driven generator, or a micro-electromechanical system (MEMS) (e.g., a fuel driven turbine engine) may be included in the charging base station for providing power to charge the capacitor power source of the dental curing light.

In one example the system may be configured to provide a substantially complete charge to the capacitor power supply within about five minutes or less, preferably within about three minutes or less, and more preferably within about one minute or less.

The one or more capacitors of the power supply do not rely on a chemical energy storage system as batteries do. As such, the capacitor power supply advantageously may be recharged tens of thousands of times without significant degradation, thus eliminating the need to replace the power supply, as is often the case with rechargeable batteries, which lose the capacity to hold a charge over time. In one example, the system may be configured such that the capacitor power supply of the dental curing light has a lifetime of at least about five hundred recharge cycles, preferably at least about one thousand recharge cycles, and more preferably at least about ten thousand recharge cycles.

These and other benefits, advantages and features of the present invention will become more full apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1A illustrates a perspective view of an exemplary dental curing light;

FIG. 1B illustrates an exploded view of the dental curing light of FIG. 1A, including at least one capacitor power source disposed within the body housing;

FIG. 1C illustrates another perspective view of the dental curing light of FIG. 1A, showing a number of controls disposed on the body housing;

FIG. 2 illustrates a graph charting the spectral irradiance of a dental curing light of the invention including a 380 nm LED and a 460 nm LED;

FIG. 3 illustrates an exploded view of another exemplary dental curing light that includes a power source comprising a plurality of capacitors disposed within the housing of the dental curing light;

FIG. 4 illustrates another exemplary dental curing light that includes a bulb (e.g., a halogen or plasma arc bulb) light source and a capacitor power source disposed within the housing of the curing light;

FIG. 5A illustrates a dental curing light system including a dental curing light and a charging base station configured to receive the dental curing light and charge the capacitor power source of the dental curing light; and

FIG. 5B illustrates a dental curing light system including a dental curing light and a charging base station configured to receive the dental curing light and charge the capacitor power source of the dental curing light by inductance such that the body of the dental curing light may be water-tight.

### DETAILED DESCRIPTION OF THE PREFERRED EMBODIMENTS

I. Introduction and Definitions

A detailed description of the invention will now be provided with specific reference to Figures illustrating various exemplary embodiments. It will be appreciated that like structures will be provided with like reference designations

The present invention is directed to a dental curing light including a body defining a housing, at least one light generating device disposed on or within the housing, and a power source comprising at least one capacitor disposed within the housing for providing power to the at least one light generating device. To help clarify the scope of the invention, certain terms will now be defined.

As used herein, the terms “light source” and “light generating device” include any light emitting device that generates light, whether a halogen or plasma arc bulb, an LED, an LED array, or other light generating source.

The terms “LED” and “LED light source,” as used herein, generally refer to one or more LEDs, one or more LED arrays, or any combination of the above that is capable of generating radiant energy. The light emitted by an LED light source includes a limited spectrum of wavelengths with a peak wavelength that corresponds with the rating of the LED light source.

The term “spectrum of light” refers to light that is monochromatic or substantially monochromatic, as well as light that falls within a range of wavelengths.

The term “capacitor” refers to a capacitative power storage device including plates or foils separated by thin layers of dielectric material (e.g., air, mica, or other known dielectric material). The plates or foils are separated by the dielectric material between the plates or foils. A voltage can be applied to the plates or foils to cause them to assume opposite charges. The stored charge can be selectively released to provide an electrical current and voltage (e.g., to power a light source).

The term “induction,” refers to electromagnetic recharging, or any other similar recharging method that can be used to charge a capacitor power source without the use of exposed electrical contacts and that will enable the dental curing light to comprise a water-tight body.

### II. EXEMPLARY DENTAL CURING LIGHTS AND SYSTEMS

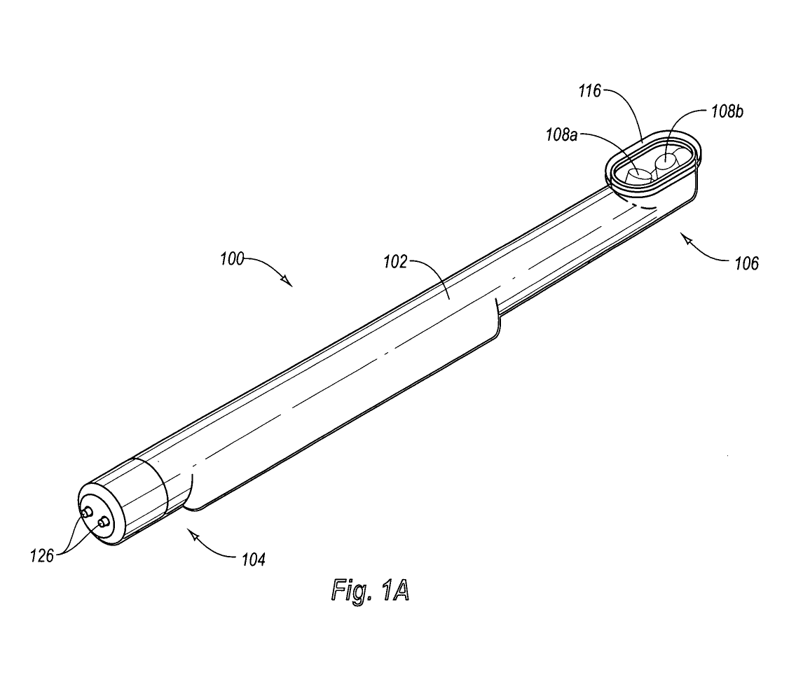

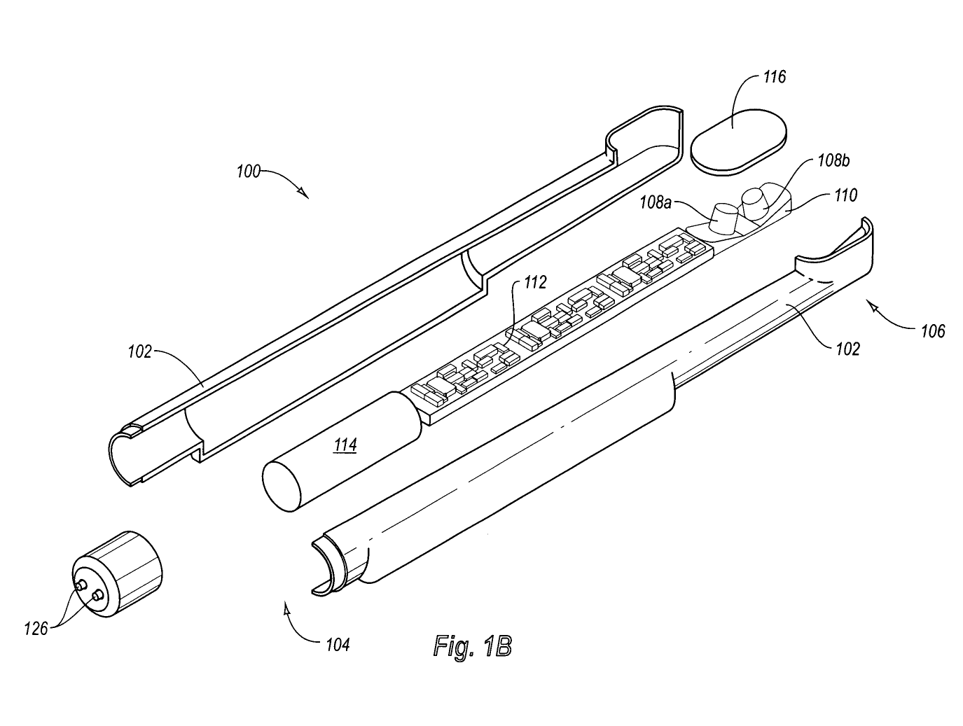

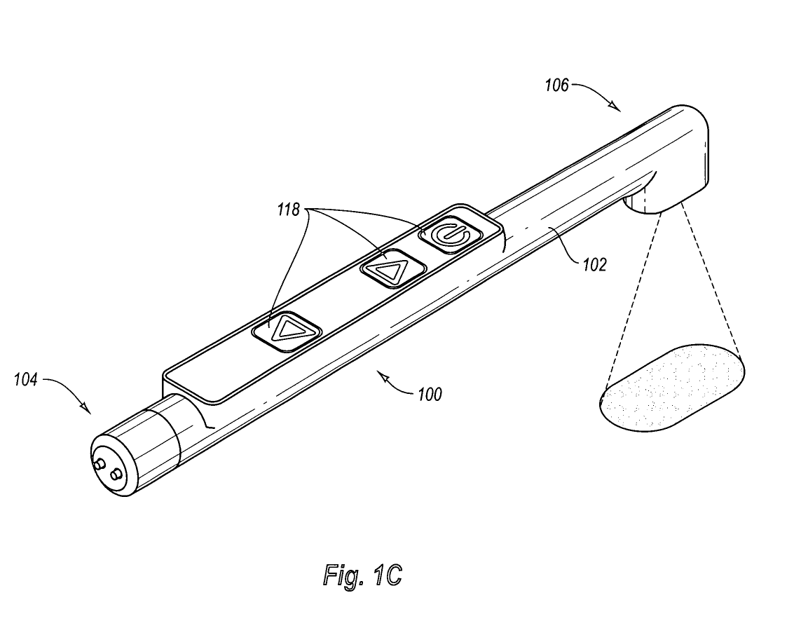

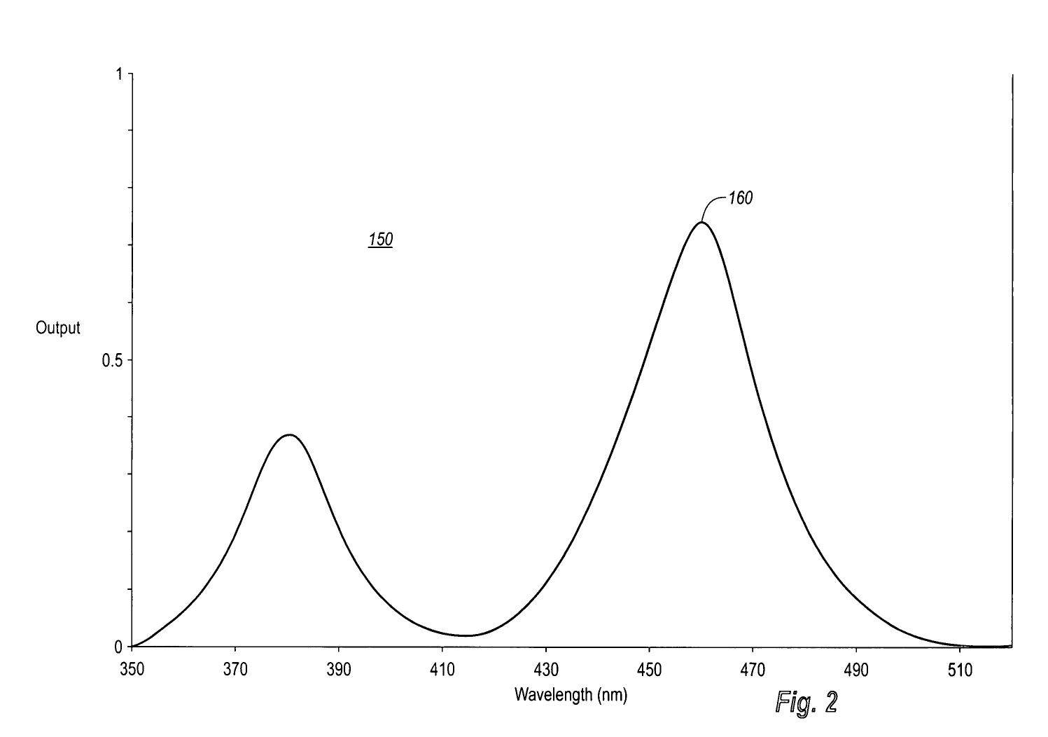

FIGS. 1A-1C illustrate an exemplary dental curing light 100. Dental curing light 100 includes a body having a housing 102 which may be configured as a sleek and slender elongate wand housing having a proximal end 104 and a distal end 106. Dental curing light 100 is illustrated as including two LEDs 108a and 108b fixedly disposed on or within housing 102. LEDs 108a and 108b are disposed near distal end 106 of curing light 100. As seen in FIG. 1B, LEDs 108a and 108b may be mounted to a heat sink 110. LEDs 108a and 108b may be configured to emit the same peak wavelength or different peak wavelengths (e.g., as illustrated in FIG. 2). A printed circuit board 112 may also be disposed within housing 102. At least one capacitor power source 114 is also disposed within housing 102. Although illustrating one capacitor 114, it is to be understood that two or more capacitors may be included, according to the power source electrical requirements desired (e.g., voltage, capacitance, current, and power). Capacitor power source 114 is electrically connected with LEDs 108a and 108b so as to provide power to LEDs 108a and 108b, causing them to emit one or more curing wavelengths. The capacitor power source 114 may also provide power for the other components (e.g., PCB 112, control buttons, indicator lights, sounds, etc.) within the dental curing light.

Dental curing light 100 may advantageously include circuitry (e.g., mounted on printed circuit board 112) configured to regulate the voltage and/or current delivered to LEDs 108a and 108b by capacitor power source 114. Exemplary voltage and/or current regulators that may be suitable for this purpose are available from LED DYNAMICS, located in Randolph, Vt. For example, such a regulator may be used to regulate the current so as to deliver a substantially constant current at a substantially constant voltage to the one or more LEDs during the duration of illumination of the LED or LEDs, even as the power from capacitor power source 114 is progressively drained (i.e., without regulation, a capacitor may deliver power at a slowly decreasing current and/or voltage as capacitor power source 114 is progressively drained). Such an embodiment is advantageous as it may allow the LEDs to provide a substantially constant flux of light, preventing or eliminating the possibility that a high flux of light is unintentionally provided when the capacitor is fully charged as compared to when the capacitor is nearly drained.

One particular advantage of capacitor power source 114 as compared to a battery power source is the ability of the capacitor power source to deliver a relatively high current when needed (e.g., during start up of the light source), independent of the charge status of the capacitor. In other words, the capacitor power source can provide needed high current even when the capacitor power source is nearly drained. Such high current delivery may not be possible or practical with many battery power sources (e.g., with many newer, lighter weight battery power sources), which may be limited to relatively low current delivery, particularly when the battery power source is nearly drained.

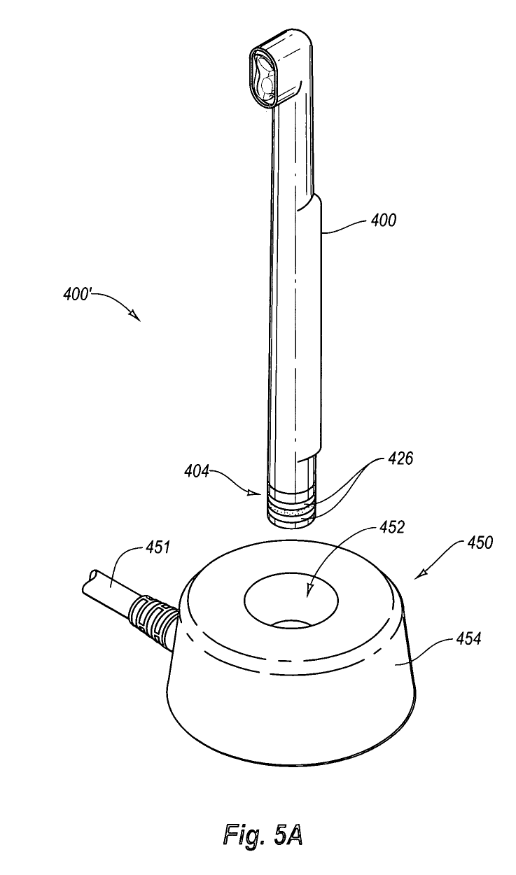

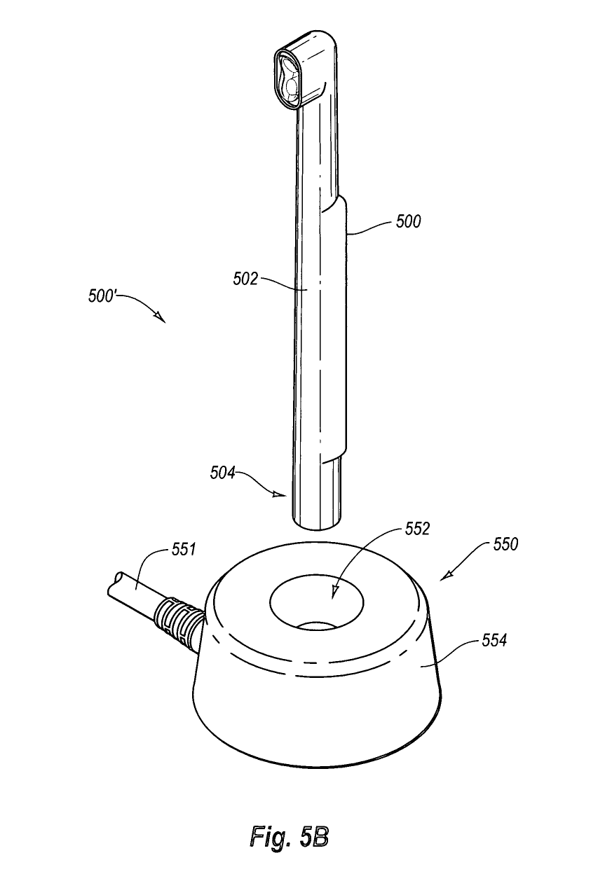

Dental curing light 100 may further include electrical contacts 126 (e.g., pins circumferential bands, or other shape) that may be configured to electrically couple with corresponding electrical contacts of a recharging base station. The power source 114 of the dental curing light 100 can be recharged when the electrical contacts 126 of dental curing light 100 are electrically coupled to corresponding contacts of the charging base station. One such example is further described below in conjunction with FIG. 5A.

The dental curing light may further include a lens 116 connectable to the distal end 106 of dental curing light 100 so as to cover LEDs 108a and 108b. Such lenses may be desirable to change the footprint shape of emitted light by focusing, diffusing or otherwise modifying the light emitted. Examples of such lenses are disclosed in U.S. patent application Ser. No. 10/423,275 filed Apr. 25, 2003 and entitled LIGHT EMITTING SYSTEMS AND KITS THAT INCLUDE A LIGHT EMITTING DEVICE AND ONE OR MORE REMOVABLE LENSES, hereby incorporated by reference with respect to its disclosure of lenses.

The dental curing light 100 may include controls disposed on the body for selectively controlling operation of LEDs 108a and 108b (or other light sources). The controls may comprise any suitable control system. FIG. 1C illustrates one exemplary control system including multiple buttons (e.g., buttons 118) disposed on elongate wand body 102. Buttons 118 or another control system may allow activation of the light source or sources on or within housing 102, as desired.

FIG. 2 illustrates a graph 150 charting the spectral irradiance of an exemplary dental curing light including two LEDs, each configured to emit a different peak wavelength. For example, in the embodiment illustrated in FIGS. 1A-1C LED 108a may be configured to emit a peak wavelength of about 380 nm, while LED 108b may be configured to emit a peak wavelength of about 460 nm. Spectral irradiance 160 includes a first peak at about 380 nm and a second peak at about 460 nm. Like a dental curing light including a bulb light source, such a dental curing light is useful for curing both camphorquinone initiated compositions and adhesives that include a UV sensitive initiator as the spectral irradiance 160 includes both a UV component (i.e., a 380 nm peak) and a blue component (i.e., a 460 nm peak). Advantageously, such a spectral irradiance can be achieved with a much lower power requirement with the two LEDs than with a bulb light source. Such a configuration is particularly well suited for use with a capacitor power source, which can easily provide the necessary power to the LEDs.

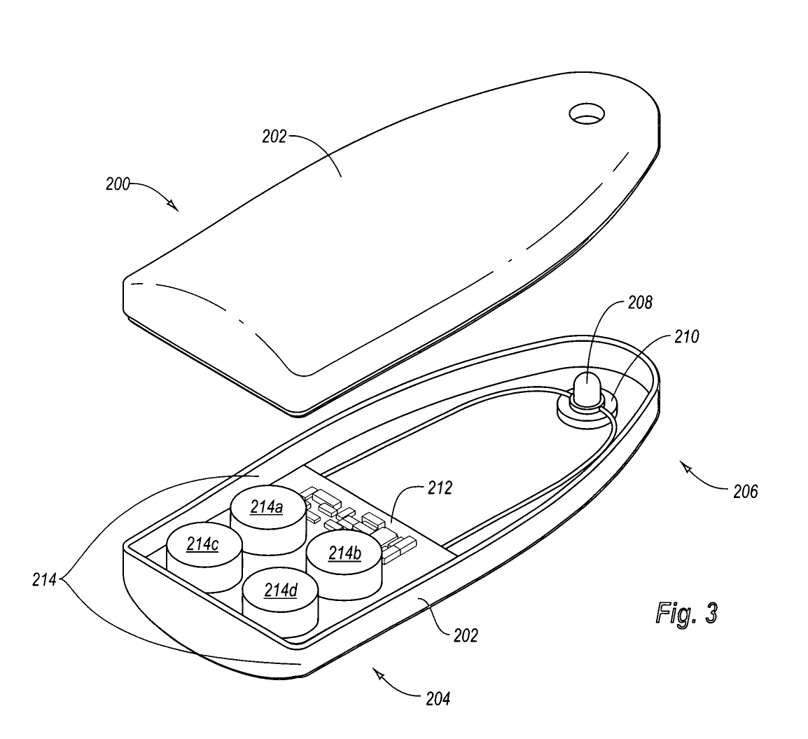

FIG. 3 illustrates an exploded view of an alternative dental curing light 200 including an body having a housing 202 including a proximal end 204 and a distal end 206. The illustrated embodiment of dental curing light 200 includes at least one LED 208 fixedly disposed within housing 202, a heat sink 210 for dissipating heat from LED 208, a printed circuit board 212, a capacitor power source 214, and electrical contacts (not shown) for charging capacitor power source 214.

Capacitor power source 214 includes four capacitors 214a, 214b, 214c, and 214d. One or more of the four capacitors may be wired in parallel or in series with one or more of the other capacitors. For example, Capacitor 214a may be wired in parallel with capacitor 214b, and capacitor 214c may be wired in parallel with capacitor 214d. The parallel combination of capacitors 214a and 214b may be wired in series with the parallel combination of capacitors 214c and 214d. Electrical connections between the plurality of capacitors are not illustrated in FIG. 3 for purposes of clarity although it is to be understood that the capacitors are electrically connected. In one embodiment, the electrical wiring connections may be made through the printed circuit board. Wiring capacitors in parallel increases the total capacitance of the capacitor group (e.g., wiring two 50 farad capacitors in parallel provides a capacitor group having a capacitance of 100 farads). Wiring capacitors in series increases the total voltage of the capacitor group (e.g., wiring two 5 volt capacitors in series provides a capacitor group having a voltage of 10 volts). The above described wiring configuration of four capacitors provides both increased voltage and increased capacitance as compared to an individual capacitor (e.g., if each capacitor 214a, 214b, 214c, and 214d is rated 50 farads at 5 volts, then the wiring configuration as described would provide a capacitor power source rated 100 farads at 10 volts). Various other wiring configurations will be apparent to one skilled in the art.

Because of their efficiency, LEDs only require a relatively small amount of power in order to produce a sufficient intensity of light for curing a light curable composition. By way of comparison, a typical bulb light source may require 85 watts, while an LED that delivers approximately the same intensity of a curing wavelength may only require about 5 watts. The low power requirements of LEDs make them particularly well suited for use with a capacitor power supply. This is because although capacitors may not hold as much power as a similar sized battery, an LED only requires a small amount of power, and the capacitor can be quickly recharged. Thus, the combination of a capacitor power source and an LED light source is particularly advantageous as sufficient power is provided by the capacitor to drive the LED (which is typically driven for short time periods), and the capacitor can be recharged very quickly for reuse without the recharge limitations associated with batteries (i.e., long recharge times, relatively short recharge cycle lifetimes, and generation a significant amount of heat during recharging).

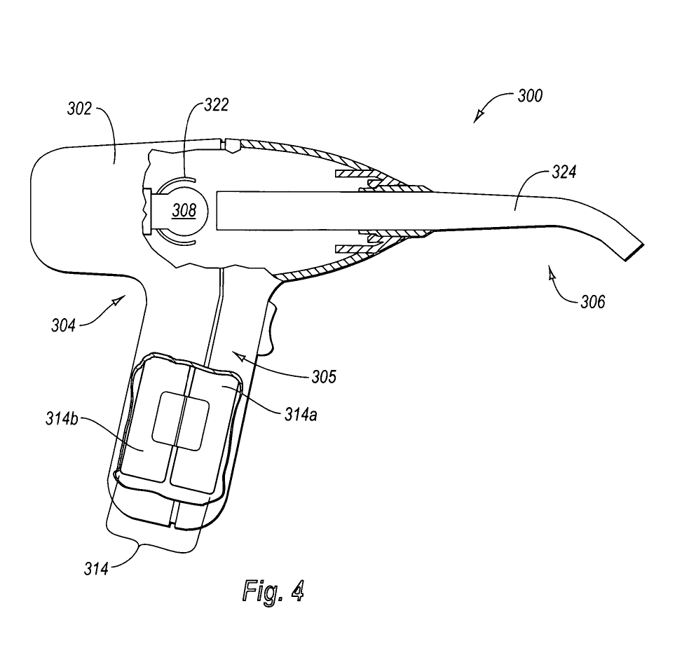

Although the combination of an LED light source powered by a capacitor power source is particularly advantageous as described above, it is within the scope of the invention to use a capacitor power source with a dental curing light having a bulb light source, although such a configuration may be less preferred. FIG. 4 illustrates a partial cut away side view of an alternative dental curing light 300 including a housing 302 having a proximal end 304 and a distal end 306. Housing 302 also includes a handle position 305. The illustrated embodiment of dental curing light 300 includes a bulb (e.g., halogen or plasma arc) 308 fixedly mounted within housing 302, and a reflector 322 located adjacent light source 308 so as to redirect light into an end of fiber optic light guide 324. Dental curing light 300 includes a capacitor power source disposed within housing 302 (e.g., in handle 305). Capacitor power source 314 includes a first capacitor 314a and a second capacitor 314b. Both capacitors may be electrically connected to bulb 308 (e.g., either in series or parallel) so as to provide power to bulb 308. Dental curing light 300 may include electrical contacts (not shown) so as to allow electrical recharging contact with a recharging base station to charge capacitor power source 314. Dental curing light 300 advantageously may have greater mobility as compared to a corded dental curing light using a bulb light source, and it may be more quickly recharged as compared to a battery powered dental curing light. In addition, the capacitor power source 314 may be rechargeable as many as tens of thousands of times, which is particularly advantageous as compared to a battery powered curing light.

FIG. 5A illustrates a dental curing light system 400′ including a dental curing light 400 and a charging base station 450 including a power cord 451 configured for connection to a power outlet. The illustrated charging base station 450 includes a dental curing light holder 452 (e.g., an internal cavity) that is configured to physically couple (e.g., by friction fit) with the proximal end 404 of dental curing light 400. Dental curing light 400 is illustrated as including electrical contacts 426 which circumferentially extend around dental curing light 400. Circumferentially extending electrical contacts 426 may be particularly advantageous as it allows the dental curing light 400 to be inserted into holder 452 without respect to any rotational alignment between the electrical contacts 426 and corresponding electrical contacts within the recharging base station 450. Although circumferentially extending contacts may be preferred, an alternative pin like electrical contact configuration as illustrated in FIGS. 1A-1C may alternatively be used. The recharging base station 450 can be configured with corresponding electrical contacts (not shown) that are positioned at different relative heights within holder 452. This will enable the electrical contacts of the charging base station to engage the corresponding electrical contacts 426 that are correspondingly positioned on the dental curing light 400 at different heights once the dental curing light 400 is mounted within charging base station 450. In other words, electrical contacts 426 and corresponding contacts disposed on the inside surface of holder 452 are configured so as to make electrical contact with each other when proximal end 404 of dental curing light 400 is received within dental curing light holder 452.

Charging base station 450 includes a housing 454 that is connected with the hand piece holder 452 in such a way that the charging base station 450 is configured to set on a relatively flat surface in an upright position. The size, shape and weight of the housing is also configured to support the charging base station 450 in an upright position even when the dental curing light 400 is mounted within the hand piece holder 452.

Additional details regarding charging base stations, charging electrical contacts formed on or in the dental curing light and electrical coupling configurations between the charging base station and the dental curing light are disclosed in U.S. patent application Ser. No. 10/740,000 filed Dec. 17, 2003 and entitled RECHARGEABLE DENTAL CURING LIGHT, herein incorporated by reference. In one example the charging base station is incorporated into a standard dental hand piece holder including means for attaching the holder to a standard dental hand piece holding tray. Such an example allows the rechargeable dental curing light to be stored and recharged chair-side with other dental hand pieces (e.g., high speed turbines, low speed turbines, ultrasonic devices, and 3-way syringes) in its own standard dental hand piece holder.

FIG. 5B illustrates another dental curing light system 500′ including a dental curing light 500 and a charging base station 550 including a power cord 551 configured for connection to a power outlet. The illustrated charging base station 550 includes a dental curing light holder 552 (e.g., an internal cavity) surrounded by a housing 554. Holder 552 is configured to receive the proximal end 504 of dental curing light 500. The dental curing light 500 is illustrated as including a body that is water-tight, without any exposed electrical contacts. In such an embodiment, the capacitor power source of the dental curing light may be configured with components that enable charging of the at least one capacitor through induction. To enable charging through induction, the dental curing device may include electromagnetic components (not shown) sealed within the body of dental curing light 500 (e.g., near proximal end 504). The sealed electromagnetic components interact with corresponding electromagnetic components (not shown) of the charging base station 550.

In one embodiment, the electromagnetic components of the dental curing light 500 react to magnetic fields that are created by the flow of current through at least some of the electromagnetic components of the charging base station 550. To generate the desired magnetic fields, current can pulsate through the electromagnetic components of the charging base station 550 or the electromagnetic components of the charging base station 550 can be moved relative to the electromagnetic components of the dental curing light 500, while current is steadily flowing through the electromagnetic components of the charging base station 550. As will be appreciated by those of skill in the art, this can create a flow of current in the electromagnetic components of the dental curing light 500 that can be used to charge the at least one capacitor of the power source.

One benefit of recharging dental curing light 500 through induction is that it facilitates manufacturing dental curing light 500 with a water-tight housing, since no electrical contacts need to be exposed outside of the body 502. It will also be appreciated that a water-tight body can be useful for enabling the dental curing light 500 to be cleaned without risking damage to the electrical contacts, and while reducing or eliminating any chance that internal components may be exposed to and damaged by exposure to water and other solutions during cleaning. To provide water-tight capabilities, the body of the dental curing light can be formed from a plastic, examples of which include but are not limited to: a polyurethane, polyester, polycarbonate, nylon, TEFLON, or combinations thereof.

The systems of FIGS. 5A-5B describe exemplary systems where the dental curing light may be charged through coupling to a charging base station that is connected to a power outlet. It is to be understood that alternative configurations may be possible. For example, the changing base station may include a fuel cell, an air drive generator, a MEMS turbine engine that runs on fuel (e.g., methanol), even a battery, or other component for providing recharging power to the capacitor power source. Such a configuration may be advantageous as no power cord and outlet are required, which may be advantageous when using the system in a remote area (e.g., Third World charity work) without easily accessible power.

At least some such configurations may not even require a charging base station. For example, the power source of the dental curing light may include a non-capacitor power source in addition to the at least one capacitor, the non-capacitor power source being configured for recharging the capacitor. For example, a small fuel cell or other small, lightweight power source may be incorporated into the dental curing light so as to provide power for charging the capacitor of the power source.

The capacitor power source is quickly rechargeable to its full capacity. By substantially complete charge, what is meant is that when charging the capacitor power source under normal conditions, a substantially complete charge occurs when the current flowing into the capacitor drops to substantially zero. In one example the system is advantageously configured to provide a substantially complete charge to the capacitor power supply within about five minutes or less, preferably within about three minutes or less, and more preferably within about one minute or less. Such short recharge times are particularly advantageous as they allow the dental practitioner to use the dental curing light, and then recharge the capacitor power supply quickly for reuse. Such a short recharge time is particularly advantageous as compared to a rechargeable battery power supply. For example, if the power supply needs to be recharged mid-procedure or between patients, it can quickly be accomplished with a capacitor power supply. In addition, recharging the capacitor power supply typically generates almost no noticeable waste heat, as compared to battery power supplies (particularly so called “fast charging” battery packs) that may become very hot to the touch during charging.

Also advantageously, the one or more capacitors of the power supply do not rely on a chemical energy storage system as batteries do. As such, the capacitor power supply advantageously may be recharged tens of thousands of times without significant degradation. In one example, the system may be configured such that the capacitor power source of the dental curing light has a lifetime of at least about five hundred recharge cycles, preferably at least about one thousand recharge cycles, and more preferably at least about ten thousand recharge cycles. Such long recharge cycle lifetimes are particularly advantageous as compared to typical battery power supplies which have claimed lifetime recharge cycles of no more than 200-300 charges. In actual practice, the number of cycles is probably much less.

In addition, battery power supplies are known to suffer from a “memory effect.” Over the course of the life of the battery, this memory effect reduces the charge that the battery will take during recharge, particularly towards the end of the total lifetime of the battery (i.e., a battery will not take the same charge on its 100^{th} charge as it did on its 10^{th} or 1^{st} charge). This memory effect reduces the actual number of recharge cycles obtained in actual practice from a battery pack as older batteries must be replaced because they hold very little charge. No such memory effect affects a capacitor power supply.

It will be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A dental curing light comprising:
a body including a housing;
at least one light generating device disposed on or within the housing, the at least one light generating device being adapted to generate at least a first spectrum of light; and
a power source disposed within the housing for providing power to the at least one light generating device, the power source comprising at least one capacitor.

2. A dental curing light as recited in claim 1, wherein the body comprises an elongate wand housing.

3. A dental curing light as recited in claim 1, wherein the power source comprises a plurality of capacitors, and wherein at least some of the capacitors are wired in series.

4. A dental curing light as recited in claim 1, wherein the power source comprises a plurality of capacitors, and wherein at least some of the capacitors are wired in parallel.

5. A dental curing light as recited in claim 1, wherein the power source comprises at least two capacitors wired in parallel and at least two capacitors wired in series.

6. A dental curing light as recited in claim 1, further comprising circuitry configured to regulate at least one of the current or voltage delivered to the at least one light generating device by the at least one capacitor of the power source.

7. A dental curing light as recited in claim 1, wherein the at least one light generating device comprises at least one LED adapted to emit at least a first peak wavelength.

8. A dental curing light as recited in claim 7, wherein the at least one light generating device comprises at least two LEDs disposed on or within the housing, the LEDs including at least one LED configured to emit a first spectrum of light having a first peak wavelength, and at least one other LED configured to emit a second spectrum of light having a second peak wavelength different from the first peak wavelength.

9. A dental curing light as recited in claim 8, wherein at least one LED is configured to emit a first spectrum of light having a first peak wavelength within a UV range.

10. A dental curing light as recited in claim 8, wherein at least one LED is configured to emit a first spectrum of light having a first peak wavelength within a blue range.

11. A dental curing light as recited in claim 1, wherein the at least one capacitor of the dental curing light has a lifetime of at least about 500 recharge cycles.

12. A dental curing light as recited in claim 1, wherein the at least one capacitor of the dental curing light has a lifetime of at least about 1,000 recharge cycles.

13. A dental curing light as recited in claim 1, wherein the at least one capacitor of the dental curing light has a lifetime of at least about 10,000 recharge cycles.

14. A dental curing light as recited in claim 1, wherein the power source further comprises at least one of a fuel cell, an air-driven generator, or a MEMS for recharging the at least one capacitor.

15. A dental curing light system comprising:
a dental curing light comprising:
a body including a housing;
at least one light generating device disposed on or within the housing, the at least one light generating device being adapted to generate at least a first spectrum of light;
a power source disposed within the housing for providing power to the at least one light generating device, the power source comprising at least one capacitor; and
a charging base station configured to at least partially receive the dental curing light, the charging base station being configured to charge the at least one capacitor of the dental curing light when the dental curing light is at least partially received within the charging base station.

16. A dental curing light system as recited in claim 15, wherein the system is configured to provide a substantially complete charge to the at least one capacitor of the dental curing light within about 5 minutes or less.

17. A dental curing light system as recited in claim 15, wherein the system is configured to provide a substantially complete charge to the at least one capacitor of the dental curing light within about 3 minutes or less.

18. A dental curing light system as recited in claim 15, wherein the system is configured to provide a substantially complete charge to the at least one capacitor of the dental curing light within about 1 minute or less.

19. A dental curing light system as recited in claim 15, wherein the charging base station is configured to charge the at least one capacitor of the dental curing light by induction.

20. A dental curing light as recited in claim 15, wherein the charging base station further comprises a power cord configured to connect to a power outlet.

21. A dental curing light as recited in claim 15, wherein the charging base station further comprises at least one of a fuel cell, an air-driven generator, a battery, or a MEMS configured to recharge the at least one capacitor of the dental curing light.

22. A dental curing light comprising:
a body including a housing;
light generating means for generating light, the light generating means being disposed on or within the housing, the light generating means being adapted to generate at least a first spectrum of light; and
a power source disposed within the housing for providing power to the light generating means, the power source being selected from the group consisting of a capacitor, a fuel cell, an air-driven generator, and a MEMS.

23. A dental curing light as recited in claim 22, wherein the power source comprises at least one capacitor.
